(19) United States
(12) Patent Application Publication
(10) Pub. No.: US 2024/0135278 A1
(43) Pub. Date: Apr. 25, 2024

(54) METHODS AND INTERNET OF THINGS (IOT) SYSTEMS FOR MANAGING SMART GAS SAFETY BASED ON USER ACTIVITY

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Siwei ZENG, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/396,655

(22) Filed: Dec. 26, 2023

(30) Foreign Application Priority Data
Nov. 28, 2023 (CN) 202311595811.6

(51) Int. Cl. G06Q 10/0631; G06Q 50/06; H04L 67/306

(52) U.S. Cl. CPC G06Q 10/063116; G06Q 50/06; H04L 67/306

(57) ABSTRACT

Embodiments of the present disclosure provide a method and an Internet of Things (IoT) system for managing smart gas safety based on user activity. The method includes obtaining gas data of a gas user, determining, based on the gas data, a gas risk for the gas user, and determining at least one target on-site user based on the gas risk. The method further includes determining, based on at least the gas data of the target on-site user, an activity distribution of the at least one target on-site user, and based on the activity distribution, determining a recommended on-site time set and sending the recommended on-site time set to the at least one target on-site user.

### CROSS-REFERENCE TO RELATED APPLICATIONS

This application claims priority to Chinese Patent Application No. 202311595811.6, filed on Nov. 28, 2023, the entire contents of which are hereby incorporated by reference.

### TECHNICAL FIELD

The present disclosure relates to the technical field of Internet of Things (IoT), and in particular, relates to a method and an Internet of Things (IoT) system for managing smart gas safety based on user activity.

### BACKGROUND

With the increasingly widespread use of gas, a need for smart management of gas is also growing. When an on-site service is provided to a gas user, if the gas user is not at home, it may result in a waste of resources and even increase the cost of gas management, thus, reasonable planning of a management method is necessary.

Aiming at how to carry out reasonable planning of the management method, CN108764663B provides a method and a system for generating and managing an electric power customer portrait. The prior art transforms customer behavioral attributes into portrait labels, and constructs a three-dimensional, multi-level, and multi-perspective customer panoramic portrait in the form of labels, thus, realizing a detailed portrayal of characteristics of electric power customers. Based on the portrayal of the characteristics of the electric power customers, a customer subgrouping rule is designed to formulate differentiated marketing management strategies for different labeled customer groups. However, the prior art only formulates the differentiated marketing management strategies based on group characteristics, which is insufficient to be specific to an individual, and is unable to generate a more reasonable management strategy based on a situation of the individual.

Therefore, it is desired to provide a method and an Internet of Things (IoT) system for managing smart gas safety based on user activity, which may efficiently and accurately determine a corresponding gas safety management method for an actual situation of a user.

### SUMMARY

In response to the problem of how to provide reasonable gas safety management methods and services for different users, the present disclosure formulates corresponding gas safety management methods based on user activity, thereby achieving targeted and effective gas on-site appointments, gas maintenance inspections, gas failure analysis, or the like.

The present disclosure provides a method for managing smart gas safety based on user activity. The method comprises obtaining gas data of a gas user, determining, based on the gas data, a gas risk for the gas user, and determining at least one target on-site user based on the gas risk. The method further comprises determining, based on at least the gas data of the at least one target on-site user, an activity distribution of the at least one target on-site user, and based on the activity distribution, determining a recommended on-site time set and sending the recommended on-site time set to the at least one target on-site user.

The present disclosure also provides an Internet of Things (IoT) system for managing smart gas safety based on user activity. The (IoT) system comprises a smart gas user platform, a smart gas service platform, a smart gas safety management platform, a smart gas sensing network platform, and a smart gas object platform interacting in sequence. The smart gas safety management platform is configured to obtain gas data of a gas user, determine, based on the gas data, a gas risk for the gas user, and determine at least one target on-site user based on the gas risk. The smart gas safety management platform is configured to determine, based on at least the gas data of the target on-site user, an activity distribution of the at least one target on-site user, and based on the activity distribution, determine a recommended on-site time set and send the recommended on-site time set to the at least one target on-site user.

The present disclosure also provides a non-transitory computer-readable storage medium. The storage medium stores at least one set of computer instructions, and when a computer reads the at least one set of computer instructions in the storage medium, the computer executes the above-mentioned method for managing smart gas safety based on user activity.

Some embodiments of the present disclosure include at least the following beneficial effects: By determining the user activity through the gas data of the gas user, and further determining the target on-site user and the recommended on-site time set, relevant management strategies can be accurately pushed to the user, and an on-site service(e.g. an on-site appointment, a maintenance inspection, a failure analysis, etc.) provided to the target on-site user at an appropriate time, so as to improve rationality of the gas safety management and ensure that gas equipment can be maintained in a timely manner, improving gas safety for the gas user.

### BRIEF DESCRIPTION OF THE DRAWINGS

The present disclosure is further illustrated by way of exemplary embodiments, which are described in detail through the accompanying drawings. These embodiments are not limiting, and in these embodiments, a same numbering denotes a same structure, wherein:

FIG. 1 is a schematic diagram illustrating a structure of an Internet of Things (IoT) system for managing smart gas safety based on user activity according to some embodiments of the present disclosure;

FIG. 2 is an exemplary flowchart illustrating a method for managing smart gas safety based on user activity according to some embodiments of the present disclosure;

FIG. 3 is an exemplary schematic diagram illustrating a determination of a gas risk according to some embodiments of the present disclosure; and

FIG. 4 is an exemplary schematic diagram illustrating a determination of a predicted activity distribution using an activity prediction model according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system”, “device”, “unit” and/or “module” as used herein is a way to distinguish between different components, elements, parts, sections, or assemblies at different levels. However, these words may be replaced by other expressions if other words accomplish the same purpose.

As indicated in the present disclosure and in the claims, unless the context clearly suggests an exception, the words “a”, “an”, “one”, and/or “the” do not refer specifically to the singular but may also include the plural. In general, the terms “including” and “comprising” suggest only the inclusion of clearly identified steps and elements, which do not constitute an exclusive list, and the method or device may also include other steps or elements.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, other operations may be added to these processes or certain steps may be removed.

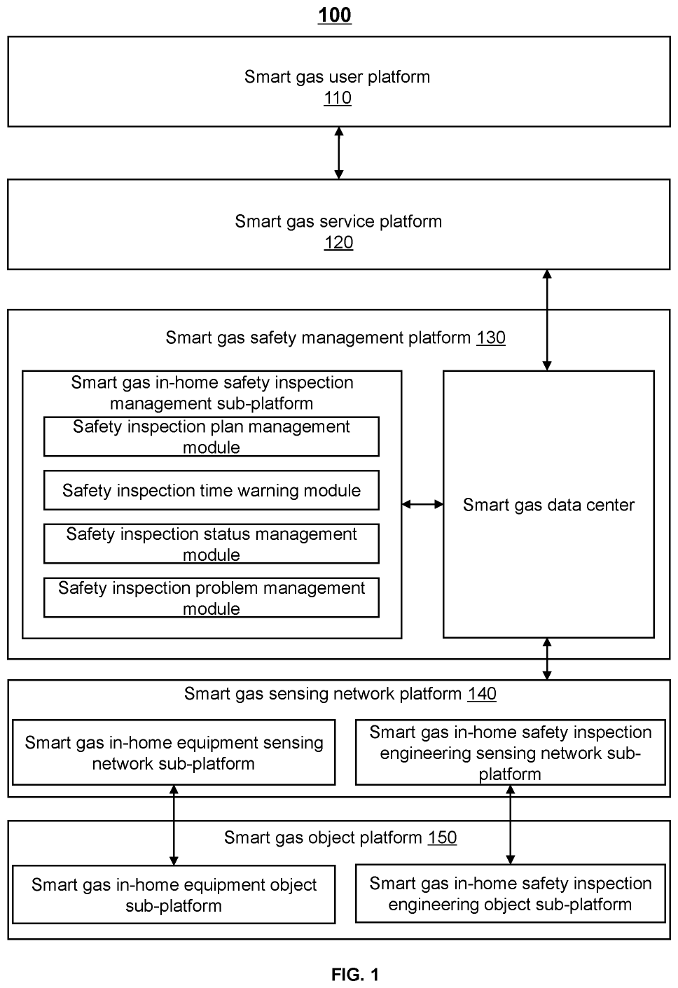

FIG. 1 is a schematic diagram illustrating a structure of an Internet of Things (IoT) system for managing smart gas safety based on user activity according to some embodiments of the present disclosure.

As shown in FIG. 1, the Internet of Things (IoT) system 100 for managing smart gas safety based on user activity may include a smart gas user platform 110, a smart gas service platform 120, a smart gas safety management platform 130, a smart gas sensing network platform 140, and a smart gas object platform 150 interacting in sequence.

The smart gas user platform 110 is a platform for interacting with a user. In some embodiments, the user platform may be configured as a terminal device.

In some embodiments, the smart gas user platform 110 may send a query command for gas usage data to the smart gas safety management platform 130 via the smart gas service platform 120, and receive a gas management plan (e.g., a recommended on-site time set, etc.) uploaded by the smart gas service platform 120.

The smart gas service platform 120 is a platform for receiving and transmitting data and/or information.

In some embodiments, the smart gas service platform 120 may receive the query command issued by the smart gas user platform 110 and forward the query command to the smart gas safety management platform 130. In some embodiments, the smart gas service platform 120 may send a gas management program to the smart gas user platform 110.

The smart gas safety management platform 130 is a platform that integrates and coordinates connection and collaboration between various functional platforms, aggregates all information of the Internet of Things (IoT) system, and provides perception management and control management functions for the operation of the IoT system.

In some embodiments, the smart gas safety management platform 130 may include a smart gas in-home safety inspection management sub-platform and a smart gas data center. In some embodiments, the smart gas in-home safety inspection management sub-platform may interact bi-directionally with the smart gas data center.

The smart gas data center may aggregate and store at least some of operational data of a system. In some embodiments, the smart gas safety management platform 130 may interact with the smart gas service platform 120 and the smart gas sensing network platform 140 through the smart gas data center.

In some embodiments, the smart gas data center may be configured as a storage device for storing gas data or the like. The gas data may be acquired by the smart gas object platform 150 and uploaded to the smart gas data center. The smart gas safety management platform 130 may retrieve the gas data directly through the smart gas data center or obtain gas data from the smart gas object platform 150 based on the smart gas sensing network platform 140.

In some embodiments, the smart gas safety management platform 130 may also be configured to obtain gas data of a gas user, determine, based on the gas data, a gas risk for the gas user, and determine at least one target on-site user based on the gas risk. The smart gas safety management platform may be configured to determine, based on at least the gas data of the target on-site user, an activity distribution of the at least one target on-site user, and based on the activity distribution, determine a recommended on-site time set and send the recommended on-site time set to the at least one target on-site user. The determined gas risk may be stored in the smart gas in-home safety inspection management sub-platform. The at least one target on-site user may be determined by the smart gas in-home safety inspection management sub-platform based on the gas risk, and the activity distribution of the target on-site user may be determined based on the gas data of the at least one target on-site user.

In some embodiments, the management sub-platform may determine the at least one target on-site user and the recommended on-site time set based on the smart gas safety management platform.

The smart gas in-home safety inspection management sub-platform is a platform configured to process safety inspection information of in-home equipment. In some embodiments, the smart gas in-home safety inspection management sub-platform may include a safety inspection plan management module, a safety inspection time warning module, a safety inspection status management module, and a safety inspection problem management module. In some embodiments, the safety inspection plan management module may be configured to set and adjust a safety inspection plan for the in-home equipment, issue the safety inspection plan to a smart gas in-home safety inspection engineering object sub-platform, and send a latest safety inspection plan to the smart gas user platform 110. In some embodiments, the safety inspection time warning module may be configured to automatically schedule a pending safety inspection plan based on a safety inspection time, and prompt a warning notification based on a preset threshold value. In some embodiments, management personnel may directly switch into the safety inspection plan management module through the safety inspection time warning module to access and reschedule a corresponding safety inspection plan. In some embodiments, the safety inspection status management module may be configured to access a historical safety inspection execution status of the in-home equipment and a next safety inspection plan. In some embodiments, the safety inspection problem management module may be used for accessing, remotely processing, sending messages, or the like of a safety inspection issue.

The smart gas sensing network platform 140 is a functional platform for managing a sensing communication. In some embodiments, the smart gas sensing network platform 140 may be configured as a communication network and a gateway to perform functions such as network management, protocol management, command management, and data parsing.

In some embodiments, the smart gas sensing network platform 140 may include a smart gas in-home equipment sensing network sub-platform and a smart gas in-home safety inspection engineering sensing network sub-platform. In some embodiments, the smart gas in-home equipment sensing network sub-platform may perform information interaction with a smart gas in-home equipment object sub-platform to obtain relevant data of the in-home equipment. In some embodiments, a smart gas safety inspection project sensing network sub-platform may perform information interaction with a smart gas safety inspection engineering object sub-platform to obtain data related to safety inspection engineering.

The smart gas object platform 150 is a functional platform configured to perceive information generation and control information execution. In some embodiments, the smart gas object platform 150 may be configured to include at least one piece of gas equipment. The at least one piece of gas equipment may be configured with a unique identifier that may be used to control pieces of gas equipment deployed in different regions of a city. The at least one piece of gas equipment may also include in-home equipment and pipeline network equipment.

In some embodiments, the smart gas object platform 150 may include the smart gas in-home equipment object sub-platform and the smart gas in-home safety inspection engineering object sub-platform. In some embodiments, the smart gas in-home equipment object sub-platform may be configured as various types of in-home equipment for the gas user. The in-home equipment may include a gas meter, an in-home gas pipe, or the like. In some embodiments, the smart gas in-home safety inspection engineering object sub-platform may be configured as various types of safety inspection equipment. The safety inspection equipment may include a gas flow meter, a pressure sensor, a temperature sensor, or the like.

In some embodiments of the present disclosure, the IoT system 100 for managing smart gas safety based on user activity can form a closed loop of information operation between the smart gas object platform and the smart gas user platform, and operates in a coordinated and regular manner under unified management of the smart gas safety management platform, realizing information-based and intelligent smart gas safety management.

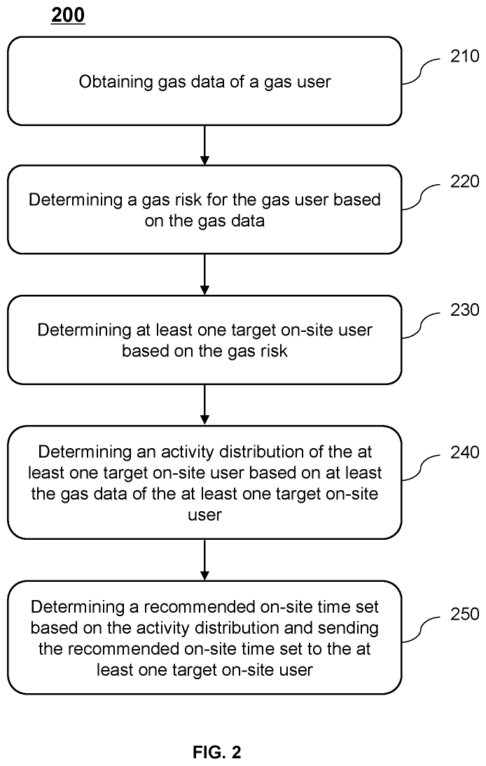

FIG. 2 is an exemplary flowchart illustrating a method for managing smart gas safety based on user activity according to some embodiments of the present disclosure. In some embodiments, a process 200 may be implemented on a smart gas safety management platform. As shown in FIG. 2, the process 200 may include the following operations 210-250.

In 210, obtaining gas data of a gas user.

In some embodiments, the gas user includes at least one gas user, and the at least one gas user satisfies a predetermined proximity condition. The satisfying the predetermined proximity condition refers to that the at least one gas user belongs to a same gas jurisdiction region.

The gas data refers to data related to gas usage. For example, the gas data may include a gas pressure, a gas usage volume, a gas usage frequency, or the like.

In some embodiments, the gas data may be acquired by a smart gas object platform and uploaded to the smart gas safety management platform via a smart gas sensing network platform.

In 220, determining a gas risk for the gas user based on the gas data.

The gas risk refers to an indicator for measuring a degree of risk associated with the gas usage. The higher the gas risk, the higher the degree of the risk associated with the gas usage.

In some embodiments, the smart gas safety management platform may conduct a comprehensive assessment based on a relationship between various types of data in the gas data and thresholds corresponding to the various types of data to determine the gas risk for the gas user. For example, the smart gas safety management platform may determine the gas risk for the gas user by using a preset formula based on the gas pressure, the gas usage volume, and the gas usage frequency included in the gas data, as well as a gas pressure threshold, a gas usage volume threshold, and a gas usage frequency threshold corresponding to the gas pressure, the gas usage volume, and the gas usage frequency, respectively. An exemplary preset formula may be denoted as the following formula:

$$S = {k}_{1} \times \vert {A}_{1} - {A}_{2} \vert + {k}_{2} \times \vert {B}_{1} - {B}_{2} \vert + \frac{\vert {C}_{1} - {C}_{2} \vert}{{C}_{2}}$$

wherein S denotes the gas risk, k₁ and k₂ denote preset coefficients, A₁ denotes the gas pressure, A₂ denotes the gas pressure threshold, B₁ denotes the gas usage volume, B₂ denotes the gas usage volume threshold, C₁ denotes the gas usage frequency, and C₂ denotes the gas usage frequency threshold. The above formula is intended to be an example only and does not limit the manner of determining the gas risk.

In some embodiments, the smart gas safety management platform may also construct a gas user profile based on the gas data and determine the gas risk based on the gas user profile. Specific details regarding this embodiment may be found in FIG. 2 and the related descriptions thereof.

In 230, determining at least one target on-site user based on the gas risk.

The target on-site user refers to a gas user who requires on-site service.

In some embodiments, the smart gas safety management platform may identify a gas user whose gas risk reaches a risk threshold as the target on-site user. The risk threshold may be set by a technician based on experience. The risk threshold may also be determined in other feasible ways, which are not limited herein.

In 240, determining an activity distribution of the at least one target on-site user based on at least the gas data of the at least one target on-site user.

The activity distribution refers to a distribution of frequency data of the gas usage by a gas user in different time intervals within a preset time period. The preset time period and the different time intervals may be preset. For example, the preset time period may be a day, etc., and the different time intervals may be divided by hour, or the like.

In some embodiments, the smart gas safety management platform may determine the activity distribution based on the gas data and third-party data. For example, the smart gas safety management platform may determine whether the at least one target on-site user is at home based on the third-party data. In response to a determination that the target on-site user is not at home and the gas is not being used, an activity level for the target on-site user during this time period is determined as 0. The third-party data refers to data obtained from an external source, such as cell phone location information of the at least one target on-site user, etc.

In some embodiments, the smart gas safety management platform may determine a gas usage count and a gas usage distribution for the target on-site user in different time intervals during the preset time period based on the gas data. The smart gas safety management platform may further determine the activity distribution based on the gas usage count and the gas usage distribution. The gas usage distribution may include gas usage volumes of a plurality of counts of gas usage corresponding to a plurality of time intervals. An activity level for each of the plurality of time intervals may be obtained by performing a weighting operation on the gas usage count and a total gas usage volume in the each of the plurality of time intervals, and a weight may be preset by the IoT system or manually. Finally, the activity distribution in the preset time period may be obtained. The total gas consumption in a specific time interval may be determined based on the gas usage distribution in the time interval. The activity distribution may also be determined using any other reasonable formula, which is not limited by the present disclosure.

In some embodiments, the smart gas safety management platform may adjust the activity distribution of the at least one target on-site user based on the gas user profile of the at least one target on-site user to determine an adjusted activity distribution.

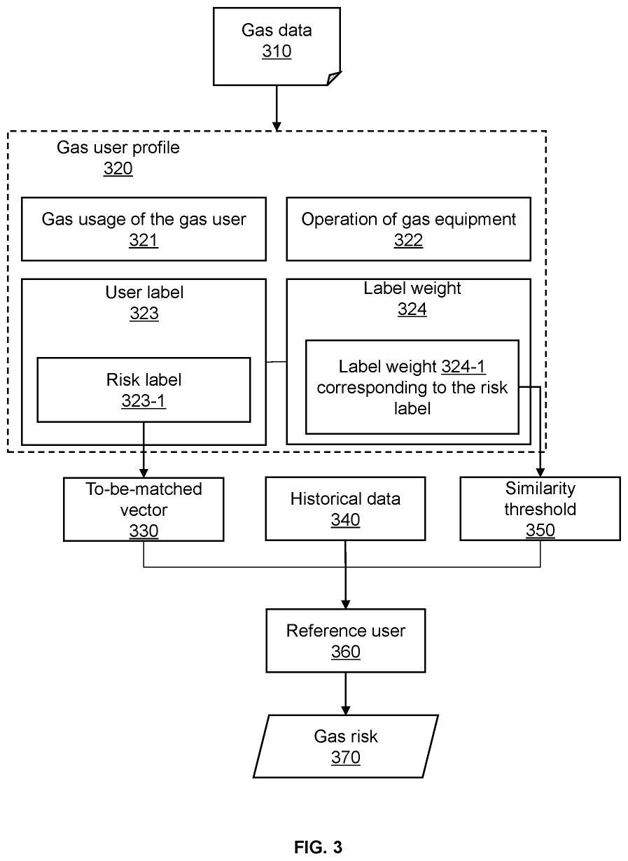

A related illustration of the gas user profile may be found in FIG. 3 and related descriptions thereof.

In some embodiments, the smart gas safety management platform may determine a target time interval based on the gas user profile, set the activity level corresponding to the target time interval to 0, and determine the adjusted activity distribution. For example, if the gas user profile includes keywords such as “underage” or “9 to 5,” the target time interval may be determined to be 09:00-17:00 based on the keywords, and the activity level corresponding to the time interval may be set to 0 accordingly.

In some embodiments of the present disclosure, adjusting the activity distribution through the gas user profile enables the exclusion of a time interval inconvenient for an on-site service, making a subsequently determined on-site service time more reasonable.

In 250, determining a recommended on-site time set based on the activity distribution and sending the recommended on-site time set to the at least one target on-site user.

The recommended on-site time set refers to a collection of times when it is recommended to perform on-site maintenance. The recommended on-site time set may include one or more recommended on-site times.

In some embodiments, the smart gas safety management platform may determine the recommended on-site time set based on the activity distribution. For example, the smart gas safety management platform may determine at least one time interval in the activity distribution where activity levels are higher than an activity threshold as the recommended on-site time set. The activity threshold may be a system default value, an empirical value, a human pre-set value, etc., or any combination thereof, which may be set according to actual needs, and may be not limited by the present disclosure.

In some embodiments, the smart gas safety management platform may determine a predicted activity distribution of the at least one target on-site user in a future time period based on the activity distribution and weather data, and determine the recommended on-site time set based on the predicted activity distribution.

The weather data refers to a weather condition in a region where the gas user is located in the future time period. The weather data may be obtained online.

The predicted activity distribution refers to a predicted activity distribution of the at least one target on-site user in the future time period. More details of the activity distribution may be found in the above related descriptions.

In some embodiments, the smart gas safety management platform may determine the predicted activity distribution in various ways based on the activity distribution and the weather data. For example, the smart gas safety management platform may obtain the predicted activity distribution by increasing an activity level of a time interval corresponding to a bad weather condition and decreasing an activity level of a time interval corresponding to a good weather condition based on an initially determined activity distribution. The weather condition may be pre-determined.

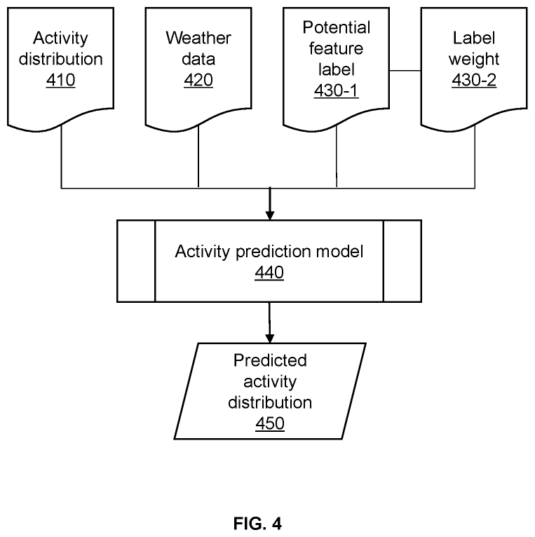

In some embodiments, the smart gas safety management platform may also determine the predicted activity distribution based on an activity prediction model. More details may be found in FIG. 4 and related descriptions thereof.

In some embodiments, the smart gas safety management platform may determine the recommended on-site time set based on the predicted activity distribution in various ways. For example, the smart gas safety management platform may determine at least one time interval in the predicted activity distribution that activity levels are above the activity threshold as the recommended on-site time set.

In some embodiments, the smart gas safety management platform may construct a user distribution graph based on a plurality of predicted activity distributions and a plurality of location distances corresponding to a plurality of target on-site users, respectively, and determine the recommended on-site time set by processing the user distribution graph using a temporal determination model.

A user location refers to a residence location of the target on-site user.

The user distribution graph is a data structure consisting of nodes and edges. The edges are used to connect the nodes, and the nodes and the edges may have attributes.

In some embodiments, the nodes of the user distribution graph correspond to gas users. A node attribute may reflect the predicted activity distribution and an expected processing time for the gas user in a future time period. The edges exist when a spatial distance between the nodes is less than a distance threshold. The distance threshold may be set by a technician based on experience. An edge attribute may be a moving time.

The expected processing time refers to the initially determined recommended on-site time. The expected processing time may be determined in advance when identifying the at least one target on-site user. The expected processing time may also be determined in the manner of determining the recommended on-site time set as described above.

The moving time refers to a time it takes to travel from one node to another node. The moving time may be obtained by statistically analyzing historical data.

In some embodiments, the temporal determination model may be a machine learning model, such as a graph neural network (GNN) model.

In some embodiments, an input of the temporal determination model may include the user distribution graph, and an output may be the recommended on-site time set.

The temporal determination model may also be other graph models, such as a graph convolutional neural network model (GCNN), or an additional processing layer may be added to the GNN model, modifying a processing technique thereof, etc.

The temporal determination model may be obtained through training. In some embodiments, the temporal determination model may be obtained by training a large count of first training samples with a first label.

In some embodiments, the first training samples may be sample user distribution graphs constructed based on the historical data, and nodes, node attributes, edges, and edge attributes of the sample user distribution graphs are similar to the nodes, the node attributes, the edges, and the edge attributes of the user distribution graph. The first label may be an actual on-site time set in the historical data. In some embodiments, the first training samples and the first label may be adjusted based on a complaint of a gas user. For example, if there is a complaint from the gas user after an on-site service, the sample user distribution graph constructed based on the historical data corresponding to the on-site service is excluded. If the gas user gives a positive review, the sample user distribution graph constructed from the historical data and corresponding to the on-site service is retained, and the actual on-site time set for the on-site service is labeled as the corresponding first label.

In some embodiments of the present disclosure, by constructing the user distribution graph and using the temporal determination model to determine the recommended on-site time set, consideration can be given to the mutual influence among various gas users, making the recommended on-site time set more aligned with the actual situations of the gas users.

In some embodiments of the present disclosure, the activity distribution and the weather data are combined to take into account various factors affecting the on-site service, making the subsequently determined recommended on-site time set more comprehensive and reasonable.

In some embodiments, the smart gas safety management platform may send the recommended on-site time set to the smart gas user platform via the smart gas service platform, thereby sending the recommended on-site time set to the at least one target on-site user.

In some embodiments of the present disclosure, by determining the user activity through the gas data of the gas user, and further determining the at least one target on-site user and the recommended on-site time set, relevant management strategies can be accurately sent to the gas user, and the on-site service (e.g., on-site appointment, maintenance inspection, failure analysis, etc.) can be carried out for the at least one target on-site user at an appropriate time, improving the rationality of gas management and ensuring timely maintenance of the gas equipment to enhance the safety of gas usage for the gas user.

FIG. 3 is an exemplary schematic diagram illustrating a determination of a gas risk according to some embodiments of the present disclosure.

In some embodiments, a smart gas safety management platform may construct a gas user profile 320 of a gas user based on gas data 310 and determine a gas risk 370 based on the gas user profile 320.

The gas user profile 320 refers to a labeled user model that is abstracted based on information related to a gas usage behavior of the gas user. The labeled user model allows for describing the gas user in terms of easily understandable and highly generalized characteristics, and facilitating computer processing.

In some embodiments, the gas user profile 320 includes at least gas usage 321 of the gas user, operation 322 of gas equipment, and a user label 323.

The gas usage 321 of the gas user refers to data related to the gas usage behavior of the gas user. For example, the gas usage 321 of the gas user may include a gas usage time, a gas usage volume, a usage frequency, or the like.

The operation 322 of gas equipment refers to data related to operation of gas equipment. For example, the operation 322 of gas equipment may include an operating time of the gas equipment, whether the gas equipment operates properly, etc.

In some embodiments, the smart gas safety management platform may obtain the gas usage of the gas user 321 and the operation 322 of gas equipment from the smart gas object platform based on a smart gas sensing network platform.

The user label 323 refers to an identifier that describes a characteristic and a behavior of the gas user. The user label 323 may be used to distinguish and categorize gas users. For example, the user label 323 may include a potential gas hazard in the gas user's home, a time period the gas user is at home, a characteristic of gas usage (e.g., the gas usage time, etc.), urgency of gas usage during different time periods, a gas user type (e.g., commercial, residential), etc.

In some embodiments, the user label 323 may be categorized as a fact label, a model label, or the like.

The fact label refers to a label related to personal information about the gas user. For example, the fact label may include an age and a gender of the gas user, a frequency of entering and leaving a community where the gas user resides, etc.

In some embodiments, the fact label may be obtained based on registration information of the gas user, reserved information from another associated platform, and recorded information. For example, if the registration information of the gas user includes male gender and age 28, the fact label may include male and an age range of 25 to 30. The another associated platform refers to an external platform that exchanges data with the smart gas safety management platform, such as a community access control recording platform, or the like.

The model label refers to a label related to a type of gas used by the gas user, such as a high-frequency type of gas used by the gas user, a low-frequency type of gas used by the gas user, etc.

In some embodiments, the model label may be determined by means of cluster analysis based on the registration information of the gas user, information from other associated platforms, or historical gas usage data. An exemplary clustering analysis process includes the following operations: multi-dimensional data of a large count of gas users is clustered to obtain a plurality of sets of clustering centers, and a clustering center of each of the plurality of sets of clustering centers serves as a model label. Based on data such as the gas usage, the operation of gas equipment, etc., each of the gas users is categorized into one or more sets of clustering centers. Then the one or more sets of clustering centers to which the gas user belongs are determined as one or more model labels for the gas user.

In some embodiments, the user label 323 includes at least a potential feature label corresponding to a potential change in the gas usage.

The potential change in the gas usage refers to a potential change in the gas usage by the gas user in the future. The potential change in the gas usage may include an increase or decrease in the gas usage volume, an increase or decrease in the gas usage time, an increase or decrease in the gas usage frequency, etc. For example, a commercial user may experience an increase in the gas usage volume due to a business transformation. As another example, a residential user may experience an increase in the gas usage volume due to the presence of a pregnant woman in the residential user's family.

The potential feature label refers to a label corresponding to the potential change in the gas usage. For example, when the potential change in the gas usage is an increase in the gas usage volume, the potential feature label may include “Gas usage volume increases”, or the like.

In some embodiments, the smart gas safety management platform may determine a reference user by matching the user label of the gas user with a user label of a historical gas user in a same time period, and determine a gas usage feature of the reference user in a subsequent time period as the potential feature label for the gas user. For example, a historical gas user whose label similarity with the user label of the gas user is greater than a similarity threshold may be determined as the reference user. The label similarity may be determined based on a vector distance. For example, in the first quarter of 2023, gas user A has the user labels of “Preparing for pregnancy” and “A family of two persons.” The gas user A matches gas user B in the first quarter of 2022 with the user labels of “Preparing for pregnancy” and “A family of two persons.” Then the gas user B is determined as the reference user for the gas user A. Based on the gas usage feature of the gas user B in the second quarter of 2022, such as an increase in the gas usage volume and being a parented a baby, “Gas usage volume increases” may be determined as the potential feature label for the gas user A.

In some embodiments, the smart gas safety management platform may determine the potential feature label based on the historical gas usage data through a predictive model or a predictive algorithm. For example, the smart gas safety management platform may use a predictive algorithm to predict a future gas usage volume of the gas user based on the historical gas usage data, and then determine the future gas usage volume as the potential feature label.

In some embodiments of the present disclosure, the potential gas feature of the gas user is added to the gas user profile, which allows for the consideration of possible changes in the gas user and obtains a more comprehensive gas user profile, thereby facilitating a more accurate determination of the gas risk.

In some embodiments, the gas user profile 320 may also include a label weight 324 corresponding to the user label 323.

The label weight 324 may be used to measure the relative importance of different user labels in the gas user profile. For example, the potential feature label may correspond to one label weight 324.

In some embodiments, the label weight 324 may be related to an associated user of the gas user, and the smart gas safety management platform may determine the label weight corresponding to the user label based on a scarcity and an importance of the user label to the associated user of the gas user.

The associated user refers to a user who has similar gas usage to the gas user. For example, if the gas user has similar gas usage with another gas user in a same region, a residential user in the region may be considered as the associated gas user of the gas user.

The scarcity of the user label to the associated user refers to a proportion of occurrence of the user label among all labels of the associated user. The lower the proportion of occurrence, the higher the scarcity.

In some embodiments, the smart gas safety management platform may determine the scarcity of the user label by determining a ratio of a total count of all user labels of all associated users to a total count of occurrences of a particular user label among all user labels of all associated users.

The importance of the user label to the associated user may reflect a degree of influence of the user label on the associated user. The greater the importance, the greater the influence.

In some embodiments, the importance of the user label to the associated user may be determined based on a count of occurrences of a particular user label among all user labels of all associated users. For example, the smart gas safety management platform may determine a reciprocal of the count of occurrences of the particular user label among all user labels of all associated users as the importance of the user label.

In some embodiments, the smart gas safety management platform may determine the label weight corresponding to the user label based on both the scarcity of the user label to the associated user and the importance of the user label to the associated user. For example, the smart gas safety management platform may determine a product of the scarcity of the user label to the associated user and the importance of the user label to the associated user as the label weight for the user label.

In some embodiments of the present disclosure, the label weight corresponding to the user label may be determined based on the scarcity and the importance of the user label to the associated user, which enables an effective and accurate measurement of relative importance of different user labels in the gas user profile, resulting in a more accurate gas user profile.

In some embodiments, the label weight 324 of the user label 323 may also be related with a correlation between the user label 323 and a user activity level. The higher a degree of correlation between the user label and the user activity level, the greater the label weight of the user label. The correlation between the user label and the user activity level may be predetermined based on prior knowledge or historical data.

In some embodiments, the smart gas safety management platform may use a semantic analysis model to extract a semantic correlation between the user label and the user activity level, and designate the semantic correlation as the correlation between the user label and the user activity level. Exemplary semantic analysis models include, but are not limited to, Fully Convolutional Networks, Deeplabv3p, Cornet, or the like.

In some embodiments, the smart gas safety management platform may determine the gas risk 370 based on the gas user profile 320 in various ways. For example, the smart gas safety management platform may determine the gas risk 370 by querying a gas risk reference table based on the gas user profile 320. The gas risk reference table may be determined based on prior knowledge or historical data. The gas risk reference table may include one or more historical gas user profiles of at least one historical gas user and a gas risk corresponding to each of the one or more historical gas user profiles.

In some embodiments, the smart gas safety management platform may construct a reference user profile based on a risk label 323-1 of the gas user and a to-be-matched vector 330; perform a matching process in the historical data 340 using the to-be-matched vector 330; determine a reference user 360 based on the match similarity and a similarity threshold 350; and determine the gas risk 370 based on a historical gas failure of the reference user 360.

The risk label 323-1 refers to a label indicating the presence of the gas risk in the gas user profile. For example, the risk label 323-1 may include “Aging of the gas equipment,” “Gas equipment exceeding the recommended lifespan,” or the like.

In some embodiments, the smart gas safety management platform may determine one or more user labels in the gas user profile that are similar to a risk semantic term as the risk label. For example, if the risk semantic term includes aging, exceeding a recommended lifespan, or the like, a user label that is similar to the risk semantic term such as “Aging gas equipment,” “Gas equipment exceeding the recommended lifespan,”, or the like, may be determined as the risk label.

The to-be-matched vector may be constructed based on the risk label in the gas user profile in various ways. For example, a to-be-matched vector p may be constructed based on a risk label (x, y) in the gas user profile, wherein x indicates that the gas equipment is aging and y indicates that the gas equipment exceeds the recommended lifespan.

The reference user 360 refers to a user who may be used as a reference for the gas risk of the gas user.

In some embodiments, the smart gas safety management platform may match the to-be-matched vector 330 with the historical data 340, and determine one or more gas users corresponding to a reference vector with a match similarity greater than or equal to the similarity threshold 350 as the reference user 360. The historical data 340 may include reference vectors constructed based on historical risk labels of a large count of gas users, and a correspondence between the reference vectors and the gas users.

The similarity threshold 350 may be determined in a variety of ways. For example, the similarity threshold 350 may be determined by the IoT system or human preset, etc.

In some embodiments, the smart gas safety management platform may determine the similarity threshold 350 based on label weights 324-1 corresponding to the risk labels. For example, the smart gas safety management platform may determine the similarity threshold 350 based on a sum of the label weights 324-1 corresponding to a plurality of risk labels.

The historical gas failure refers to a gas failure condition that occurs historically with the reference user, such as a gas leak by the reference user.

In some embodiments, the smart gas safety management platform may quantify historical gas failures of at least one reference user by averaging or weighted averaging, and determine a result of the averaging or weighted averaging as the gas risk of the gas user. Weights in the weighted averaging may be positively correlated to the match similarity.

For example, the historical gas failures may be quantified based on the following formula:

S=k₁*A₁+k₂*A₂

Wherein S represents the quantitative result of the historical gas failure, A₁ represents a count of the historical gas failures, A₂ represents an average severity of the failures, and k₁ and k₂ represent coefficients of the count of the historical gas failures and the average severity of the failures respectively, which may be set in advance.

The average severity of the failures may be determined in a variety of ways. For example, the average severity of the failures may be obtained by labeling by a person of skill in the art. As another example, the average severity of the failures may be correlated to an average maintenance time, and the longer the average maintenance time, the greater the average severity of the failures. The correspondence between the average severity of the failures and the average maintenance time may be pre-set.

In some embodiments of the present disclosure, the reference user is determined based on the gas user profile, and the gas risk is determined based on the historical gas failure of the reference user. This approach can fully take into account of the reference role of the reference user's historical gas failure in determining the gas risk of the gas user. Based on the historical gas failure of the reference user, the gas risk of the gas user may be determined more accurately.

In some embodiments of the present disclosure, the gas user profile of the gas user is constructed based on the gas data. The gas risk is determined based on the gas user profile, which describes the gas user with easily understandable and highly generalized characteristics, thereby facilitating the smart gas safety management platform in processing the gas data of the gas user and determining the gas risk.

FIG. 4 is an exemplary schematic diagram illustrating a determination of a predicted activity distribution using an activity prediction model according to some embodiments of the present disclosure.

In some embodiments, a smart gas safety management platform may process an activity distribution 410 and weather data 420 based on an activity prediction model 440 to determine a predicted activity distribution 450. More details on the weather data, the activity distribution, and the predicted activity distribution may be found in FIG. 2 and the related descriptions thereof.

The activity prediction model 440 refers to a model used to determine the predicted activity distribution. In some embodiments, the activity prediction model may be a machine learning model. For example, the activity prediction model may include a convolutional neural network (CNN) model, a neural network (NN) model, or any other customized model structures.

In some embodiments, an input of the activity prediction model 440 may include the activity distribution 410 of a gas user and the weather data 420, and an output may include the predicted activity distribution 450.

In some embodiments, the input of the activity prediction model 440 may further include a potential feature label 430-1 in a gas user profile and a corresponding label weight 430-2.

More details on the potential feature label and the label weight may be found in FIG. 3 and the related descriptions thereof.

In some embodiments, the smart gas safety management platform may obtain the activity prediction model through training based on a large count of second training samples with second labels. An exemplary training process includes the following operations: a plurality of second training samples with second labels are input into an initial activity prediction model, and a loss function is constructed based on the second labels and a prediction result of the initial activity prediction model. Then the initial activity prediction model is iteratively updated based on the loss function, and the training of the activity prediction model is completed when the loss function of the activity prediction model satisfies a preset condition. The preset condition may include convergence of the loss function, a count of iterations reaching a preset value, or the like.

In some embodiments, the second training samples and the second labels may be determined based on relevant historical data. The relevant historical data may include historical activity distributions and historical weather data.

In some embodiments, the smart gas safety management platform may chronologically divide the relevant historical data into a former part and a latter part. A historical activity distribution of the former part and historical weather data of the latter part may be used as the second training sample, while a historical activity distribution of the latter part may be used as the second label corresponding to the second training sample.

Some embodiments of the present disclosure utilize the activity prediction model to determine the predicted activity distribution and take advantage of the self-learning capability of the machine learning model to identify patterns from a large amount of historical relevant data, which allows for establishing a correlation between the historical activity distribution and the predicted activity distribution, thereby increasing the accuracy and efficiency of determining the predicted activity distribution for future time periods. By inputting the potential feature label and the corresponding label weight from the gas user profile into the activity prediction model, it is possible for the activity prediction model to consider an impact of a potential change in gas usage behavior on the activity distribution when generating the output, thereby enabling the activity prediction model to generate a more reasonable predicted activity distribution.

When describing the processes performed in the embodiments of the present disclosure in terms of the operations, the order of the operations is interchangeable if not otherwise indicated, the operations are optional, and other operations may be included in the processes.

The description of the IoT system and the modules thereof in the embodiments in the present disclosure is for descriptive convenience only and does not limit the scope of the cited embodiments. It may be possible to make any combination of modules or to form subsystems connected to other modules without departing from the principles of the IoT system.

The embodiments in the present disclosure are for the purpose of exemplification and illustration only and do not limit the scope of application of the present disclosure. To those skilled in the art, various amendments and changes that may be made under the guidance of the present disclosure remain within the scope of the present disclosure.

Some features, structures, or characteristics of one or more embodiments of the present disclosure may be suitably combined.

Aspects of the present disclosure may be performed entirely by hardware, entirely by software (including firmware, resident software, microcode, etc.), or by a combination of hardware and software. The terms “data block”, “module”, “engine”, “unit”, “component”, or “system” may be used to refer to both the aforementioned hardware and software. Additionally, aspects of the present disclosure may be manifested as one or more computer products disposed in one or more computer-readable media, the products comprising computer-readable program code.

The computer storage media may be any computer-readable medium that may be used to communicate, disseminate, or transmit a program for use by connecting to an instruction execution system, device, or apparatus. The program code in the computer storage medium may be disseminated via any suitable medium, including radio, cable, fiber optic cable, radiofrequency (RF), or the like, or any combination thereof.

The computer program code required for the operation of the various sections of the present disclosure may be written in any one or more programming languages. The program code may run entirely on the user's computer, or as a stand-alone software package on the user's computer, or partly on the user's computer and partly on a remote computer, or entirely on a remote computer or processing equipment. In the latter case, the remote computer may be connected to the user's computer through any form of network, such as a local area network (LAN) or a wide area network (WAN), or connected to an external computer (e.g., via the Internet), or in a cloud computing environment, or used as a service, such as Software as a Service (SaaS).

What is claimed is:

1. A method for managing smart gas safety based on user activity, wherein the method is implemented on a smart gas safety management platform and the method comprises:
obtaining gas data of a gas user;
determining a gas risk for the gas user based on the gas data;
determining at least one target on-site user based on the gas risk;
determining an activity distribution of the at least one target on-site user based on at least the gas data of the at least one target on-site user; and
determining a recommended on-site time set based on the activity distribution and sending the recommended on-site time set to the at least one target on-site user.

2. The method of claim 1, wherein the determining a gas risk for the gas user based on the gas data includes:
constructing a gas user profile of the gas user based on the gas data, the gas user profile including at least gas usage of the gas user, operation of gas equipment, and a user label; and
determining the gas risk based on the gas user profile.

3. The method of claim 2, further comprising:
determining an adjusted activity distribution by adjusting the activity distribution of the at least one target on-site user based on the gas user profile of the at least one target on-site user.

4. The method of claim 2, wherein the user label includes a potential feature label corresponding to a potential change in the gas usage.

5. The method of claim 2, wherein the gas user profile further includes a label weight corresponding to the user label, and the determining the gas risk based on the gas user profile includes:
constructing a to-be-matched vector based on a risk label in the gas user profile, the risk label being a user label whose semantic similarity to a risk semantic term satisfying a similarity condition;
determining a reference user based on a match similarity and a similarity threshold by matching the to-be-matched vector with historical data; and
determining the gas risk based on a historical gas failure of the reference user, wherein the similarity threshold is determined based on a label weight corresponding to the risk label.

6. The method of claim 5, wherein the label weight corresponding to the user label is related to an associated user of the gas user, and a determination manner of the label weight corresponding to the user label includes:
determining the label weight corresponding to the user label based on a scarcity of the user label to the associated user and an importance of the user label to the associated user.

7. The method of claim 1, wherein the determining a recommended on-site time set based on the activity distribution includes:
determining a predicted activity distribution of the at least one target on-site user in a future time period based on the activity distribution and weather data; and
determining the recommended on-site time set based on the predicted activity distribution.

8. The method of claim 7, wherein the determining a predicted activity distribution of the at least one target on-site user in a future time period based on the activity distribution and weather data includes:
determining the predicted activity distribution by processing the activity distribution and the weather data using an activity prediction model, the activity prediction model being a machine learning model.

9. The method of claim 8, wherein an input of the activity prediction model includes a potential feature label in a gas user profile and a label weight corresponding to the potential feature label.

10. The method of claim 7, wherein the determining the recommended on-site time set based on the predicted activity distribution includes:
constructing a user distribution graph based on a plurality of predicted activity distributions and a plurality of location distances corresponding to a plurality of target on-site users, respectively; and
determining the recommended on-site time set by processing the user distribution graph using a temporal determination model, the temporal determination model being a machine learning model.

11. An Internet of Things (IoT) system for managing smart gas safety based on user activity, comprising a smart gas user platform, a smart gas service platform, a smart gas safety management platform, a smart gas sensing network platform, and a smart gas object platform interacting in sequence, wherein
the smart gas safety management platform is configured to:
obtain gas data of a gas user;
determine a gas risk for the gas user based on the gas data;
determine at least one target on-site user based on the gas risk;
determine an activity distribution of the at least one target on-site user based on at least the gas data of the at least one target on-site user; and
determine a recommended on-site time set based on the activity distribution and send the recommended on-site time set to the at least one target on-site user.

12. The system of claim 11, wherein the smart gas safety management platform is configured to:
construct a gas user profile of the gas user based on the gas data, the gas user profile including at least gas usage of the gas user, operation of gas equipment, and a user label; and
determine the gas risk based on the gas user profile.

13. The system of claim 12, wherein the smart gas safety management platform is configured to:
determine an adjusted activity distribution by adjusting the activity distribution of the at least one target on-site user based on the gas user profile of the at least one target on-site user.

14. The system of claim 12, wherein the smart gas safety management platform is configured to:
construct a to-be-matched vector based on a risk label in the gas user profile, the risk label being a user label whose semantic similarity to a risk semantic term satisfying a similarity condition;
determine a reference user based on a match similarity and a similarity threshold by matching the to-be-matched vector with historical data; and
determine the gas risk based on a historical gas failure of the reference user, wherein the similarity threshold is determined based on a label weight corresponding to the risk label.

15. The system of claim 14, wherein the smart gas safety management platform is configured to:
determine a label weight corresponding to the user label based on a scarcity of the user label to the associated user and an importance of the user label to the associated user.

16. The system of claim 11, wherein the smart gas safety management platform is configured to:
determine a predicted activity distribution of the at least one target on-site user in a future time period based on the activity distribution and weather data; and
determine the recommended on-site time set based on the predicted activity distribution.

17. The system of claim 16, wherein the smart gas safety management platform is configured to:
determine the predicted activity distribution by processing the activity distribution and the weather data using an activity prediction model, the activity prediction model being a machine learning model.

18. The system of claim 17, wherein an input of the activity prediction model includes a potential feature label in a gas user profile and a label weight corresponding to the potential feature label.

19. The system of claim 16, wherein the smart gas safety management platform is configured to:
construct a user distribution graph based on a plurality of predicted activity distributions and a plurality of location distances corresponding to a plurality of target on-site users, respectively; and
determine the recommended on-site time set by processing the user distribution graph using a temporal determination model, the temporal determination model being a machine learning model.

20. A non-transitory computer-readable medium, comprising at least one set of instructions, wherein when executed by one or more processors of a computing device, the at least one set of instructions causes the computing device to implement the method for managing smart gas safety based on user activity, comprising:
obtaining gas data of a gas user;
determining a gas risk for the gas user based on the gas data;
determining at least one target on-site user based on the gas risk;
determining an activity distribution of the at least one target user based on at least the gas data of the at least one target user; and
determining a recommended on-site time set based on the activity distribution and sending the recommended on-site time set to the at least one target on-site user.
